(19) United States
(12) Patent Application Publication
(10) Pub. No.: US 2018/0242560 A1
(43) Pub. Date: Aug. 30, 2018

(54) SYSTEM AND METHOD FOR DETERMINING AND MANAGING THE VOLUME AND CONCENTRATION OF SANITISER OPTIMISED FOR USE IN A METHOD FOR DISINFECTING AN INTRA-OVUM SUBSTANCE APPLICATION MODULE, WITH INFORMATION ON THE AVERAGE SIZE OF THE VACCINATED AND/OR FED FERTILE EGGS BEING USED AS THE PARADIGM

(71) Applicant: César Da Silva Bastos, Campinas/SP (BR)

(72) Inventor: César Da Silva Bastos, Campinas/SP (BR)

(21) Appl. No.: 15/755,303

(22) PCT Filed: Aug. 16, 2016
(86) PCT No.: PCT/BR2016/050198

§ 371 Date: Feb. 26, 2018

(30) Foreign Application Priority Data
Aug. 26, 2015 (BR) BR102015020632-1

(51) Int. Cl. A01K 45/00

(52) U.S. Cl. CPC A01K 45/007

(57) ABSTRACT

A system and method for determining and managing the volume and concentration of sanitiser optimised for use in a method for disinfecting an intra-ovum substance application module, with information on the average size of the vaccinated and/or fed fertile eggs being used as the paradigm, represent a solution in the field of poultry farming, in particular in the poultry breeding sector, particularly useful to aid the disinfection of the components of operational modules of the breeding system, in particular the substance application module [E12], adding value in that it ensures that a volume of prepared concentrated sanitiser (Sa31) with assured quality is obtained, especially in that it exhibits titration with a concentration suitable for the batch of vaccinated/fed fertile eggs, ensuring the suitability and effectiveness in respect to the true mean age of the matrix batch, determined as a function of average egg size (Tm1), wherein for that purpose the system of the invention was designed with an architecture comprising the following modules: fertile egg batch data module (M1), action management module (M2), concentrated sanitiser module (M3), water purification module (M4) and module (M5) for preparing the prepared concentrated sanitiser.

### TERMINOLOGY

To better understand the purpose of the subject matter disclosed in and claimed in this patent application, the meaning of some terms richly cited in the body of the descriptive report is shown in which:
Poultry species: its concept refers to poultry farming that is the breeding of poultry for food production, especially meat and eggs. Among the species raised in poultry, the chicken stands out. On a much smaller scale, other avian species are also raised such as turkeys, ducks, geese, quail and ostriches;
Matrix: breeding bird, which provides fertile eggs;
Average size of fertile eggs: the larger the egg, the older the matrix and consequently the greater the contamination of the application procedure for intra egg substances;
Sanitation: although all equipment uses sodium hypochlorite as a sanitizer, there are other products that may have the same effect in different concentrations, such as: Sodium hypochlorite; Chlorine dioxide and ozone;
PLC: Programmable Logic Controller is a specialized computer, based on a microprocessor that performs control functions through software developed by the user (each PLC has its own software).
Substance application module: in which vaccination and or nutrition are performed through injector devices provided with punches and needles for each egg housing niche defined in the incubation tray, where a computerized system releases a vaccine dose, nutrients or nutritional vaccine complex for the needles. A flow structure is provided for the application of substances such as vaccines/nutrients and an independent structure used for the application flow of concentrated sanitizer applied in the disinfection of the needles after the procedure of applying substances.

### FIELD OF APPLICATION

The present title patent and subject of description and claim in this cartouche deals with an inventive solution that finds outstanding benefit in the segment of poultry, notably in the poultry breeding sector.

More specifically, the invention finds particular use when applied in aid of the disinfection operation of components of operating modules of the reproduction system, in particular the module for the substance application in in ovo fertile eggs, wherein the disinfection procedure of needles of injecting devices (vaccines, nutrients, or nutritional vaccine complex) is mandatory, but may be extended to all operative modules where there is a need for such operations.

### Demand of the Invention

In view of the field of application, the applicant has identified the following needs:
provide a greater reliability and precision in the process of treatment and storage of the water component used in the preparation of the products used for the sterilization procedure through the sanitization of needles used in the injection devices of a substance application module, such as vaccines, nutrient or nutritional vaccine complex;
provide a greater reliability and precision in the preparation of the disinfection component solution of the in ovo vaccination process, such as sodium hypochlorite, commonly used in the sanitization procedure of a substance application module, such as vaccinators; and
provide a greater assertiveness in the titration calculation of the concentration of the sanitizing solution to be applied in disinfection in the vaccination process; and
Ensure the biological integrity and safety of the environment of fertile egg handling during the development cycle, notably in the subsequent stages of vaccination/nutrition and breeding;
Reduction of the cost of sanitizing input;
Reduce set up time to prepare the volume of concentrated sanitizing solution to be loaded into the substance application module;
Reduce the risk of handling accidents during the preparation of the concentrated sanitizing solution;
Reduce the risk of accidents in the loading operation of the sanitizing solution, which is concentrated in the substance application module;

### Requirements of the Invention

In accordance with the demand of the invention, the inventor has designed the “system and process of obtaining and managing the volume and concentration of sanitizer optimized for the application in the disinfection procedure of an in ovo substance applicator module having as a paradigm the information on the average size of the vaccinated and/or fed fertile eggs” provided with novelty associated with inventive activity, since it is not obvious or evident from other techniques anticipated by the state of the art, conferring advantages from the industrial, commercial and technical points of view.

In addition, the “invention” is provided with industrial applicability, being economically feasible and therefore, meets the stringency of patentability requirements, notably as a patent of invention, as set forth in the provisions of articles 8 and 13 of Law No. 9.279.

### Fundamentals of the Technique

In order to provide veracity and to consolidate the explicit context in the topics of the introductory table, an explanation will be presented on the state of the art for the preparation, manipulation and loading of the concentrated sanitizer to be applied in the substance application module, wherein after a critical analysis of these, once evaluated by technicians with expertise in the field, will be able to identify its limiting aspects, thus consolidating the identification of the previously cited demand.

a. About the conventional technique: the conventional procedure for preparing a volume of concentrated sanitizer for use in the disinfection of needles of a substance application module can be considered archaic, since it is carried out in a totally empirical way, where the laborer, in a laboratory environment, receives the preliminary information on the average value of the batch size of fertile eggs that will be taken to the intervention of the substance application module, where in possession of this information, the volume of water to be used, the volume of sanitizer and also the concentration of this sanitizer are calculated.

Then, with the calculations in hand, the professional in possession of a sanitizing reservoir, for example sodium hypochlorite, removes the previously calculated volume and performs a titration procedure to obtain the sanitizer concentration;

Then, with the same calculations in hand the professional in possession of a water reservoir, removes the previously calculated volume of water.

Finally, the professional mixes the volume of concentrated sanitizer with the volume of water, obtaining the volume of the prepared sanitizing concentrate which will feed the substance application module, to effectively promote the disinfection of the set of needles in the post vaccination operation/nutrition.

b. Identification of problems

Although, a volume of prepared concentrated sanitizer is obtained and its use is effective in the disinfection procedure of the needles of the substance application module, the applicant has identified a number of problems of significant importance.

The archaic procedure of separation, mixing and quality of the water and sanitizing solutions is not sufficient, since there is no proper control of the quality of the same, especially of the water purification, which, if not adequate, leads to the compromise of the entire volume of the concentrated sanitizer.

Still within this scope, the assertiveness in the titration calculation of the concentration of the sanitizing solution to be applied in the disinfection process of the vaccination process is also compromised, since the titration is literaturebased on the efficiency of the sanitizer, for example sodium hypochlorite+coefficient of concentration and the operator who manipulates the sanitizer uses this data to define the concentration of the concentrated sanitizer.

In practice, what happens is that the operator works with readytouse sanitizers in high concentrations, so that there is no differentiation related to the level of contamination.

In current equipment, water is treated in isolation in relation to the substance application module, without uniformity or control over the treatment process, and subsequently the water is stored in an open environment, thus subject to contamination.

Another aspect to be considered is that water production is not performed on demand, but rather in large batches where the first volume flow logic is the first volume comings out (First In First off—FIFO) is not guaranteed.

Since effective disinfection is not carried out, the integrity and biological safety of the environment of fertile egg handling during subsequent cycles of fertile egg development are noted, notably in the subsequent stages of vaccination/nutrition and breeding;

In turn, the problem of long setup time for preparation of the volume of concentrated sanitizing solution to be loaded in the substance application module is also considerable, since that solution is prepared in isolation, requiring, once prepared, to be transported to the substance application module, which is on hold, delaying the release of the module to the next vaccination/nutrition cycle;

Depicted from the previous paragraph, it is necessary to transport the concentrated sanitizer to the substance application module, and this brings to light the eminent existence of the risk of accidents during such transport operation; and

Still within the scope of the risk of an operational accident, it is important to bring to light that it exists from the empirical manipulation of the water and the sanitizer during the preparation of the concentrated sanitizing solution.

### Proposal of the Invention

a. Objective: it is an object of the present invention to provide the list of problems and causes evidenced in the fundamentals of the technique topic, as well as to make feasible the list of needs listed in the demand of the invention topic, and therefore it is pertinent to list:
Provide a preparation and loading system of concentrated sanitizer whose architecture is integrated with the substance application module;
Provide a preparation and loading system of prepared sanitizing concentrate whose architecture is automated in all stages, configuring the automated submodule of water purification, automated submodule of preparation of concentrated sanitizer and also an automated submodule for mixing the obtained obtained purified water +concentrated sanitizer; and
Provide a preparation and loading system of concentrated sanitizer that automatically performs the titration procedure for the correct calculation of the concentration of sanitizer in the mixture to be obtained and used, taking as a paradigm the sanitary need of each batch of fertile eggs to be vaccinated, which in turn is related to the average height of the batch of fertile eggs to be considered.

### DESCRIPTION OF THE FIGURES

To complement the present description in order to obtain a better understanding of the features of the present invention, and in accordance with a preferred practical embodiment thereof, the attached description is accompanied by a set of drawings, wherein:

FIG. 1 is an illustrative representation in block diagram form of the macro system for application of concentrated sanitizer in the substance application module and in other modules;

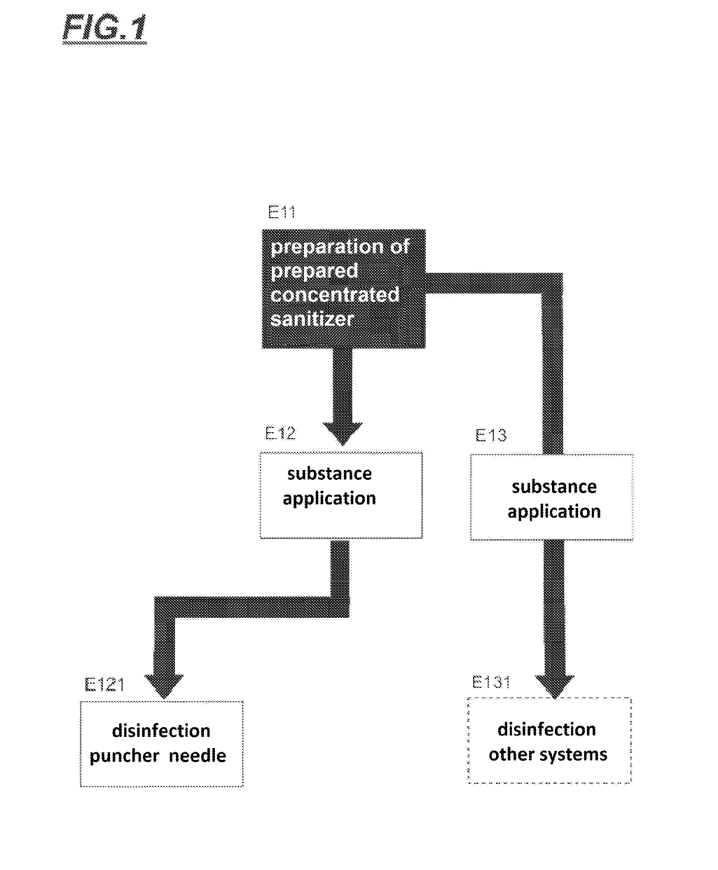

FIG. 2 is an illustrative representation in the form of block diagram of macro architecture of the system for obtaining and managing optimized volume and concentration of sanitizer for the application in the disinfection procedure of an in ovo substance applicator module having as a paradigm the information on the average size of the fertile eggs vaccinated and or fed, evidencing its operational modules;

FIG. 3 is an illustrative representation in the form of a block diagram of the macro architecture of the volume and sanitizing concentration and optimization optimized system for the application in the disinfection procedure of an in ovo substance applicator module, having as a paradigm the information on the average size of fertile eggs vaccinated and or fed, showing the submodules of its operational modules;

FIG. 4a is an illustrative representation in the form of a block diagram of the sub modules, which make up the operating water purification submodule of the system for obtaining and managing optimized volume and concentration of sanitizer;

FIG. 4b is an illustrative representation in the form of a block diagram of the devices used to make feasible the submodules that make up the operative water purification submodule of the system for obtaining and managing optimized volume and concentration of sanitizer; and

FIG. 5 is an illustrative representation in the form of a block diagram of the devices used to make feasible the submodules of the sanitizing concentrate module and of the purified water mixing module with concentrated sanitizer from the system for obtaining and managing optimized volume and concentration of sanitizer.

### DETAILED DESCRIPTION

The following detailed description should be read and interpreted with reference to the presented drawings, representing a macro level and micro level vision of the system and process of obtaining volume and concentration of sanitizer optimized for the application in the disinfection procedure of a substance applicator module having as a paradigm the information on the average size of the vaccinated and/or fed fertile eggs, and is not intended to limit the scope of the invention, this limited only to the explicit in the context of the claim.

a. State of the art: for a better understanding of the scope of application of the present inventive system, the block diagram for the sanitization system of an operational module of substances application is shown, including details for the operational modules:
sanitizing solution preparation module (E11), which is effectively the object of the present invention;
substance application module (E12), whose needle components (E121) of the injection devices are disinfected with the prepared sanitizing concentrate; and
substance application module (E13), to other devices (E131) receiving disinfection with the prepared sanitizing concentrate.

For the purpose of the present invention, the same is applied to the sanitizing solution preparation module (E11), which is described in detail as concept and operating procedure.

b. Macro Architecture of the Inventive System

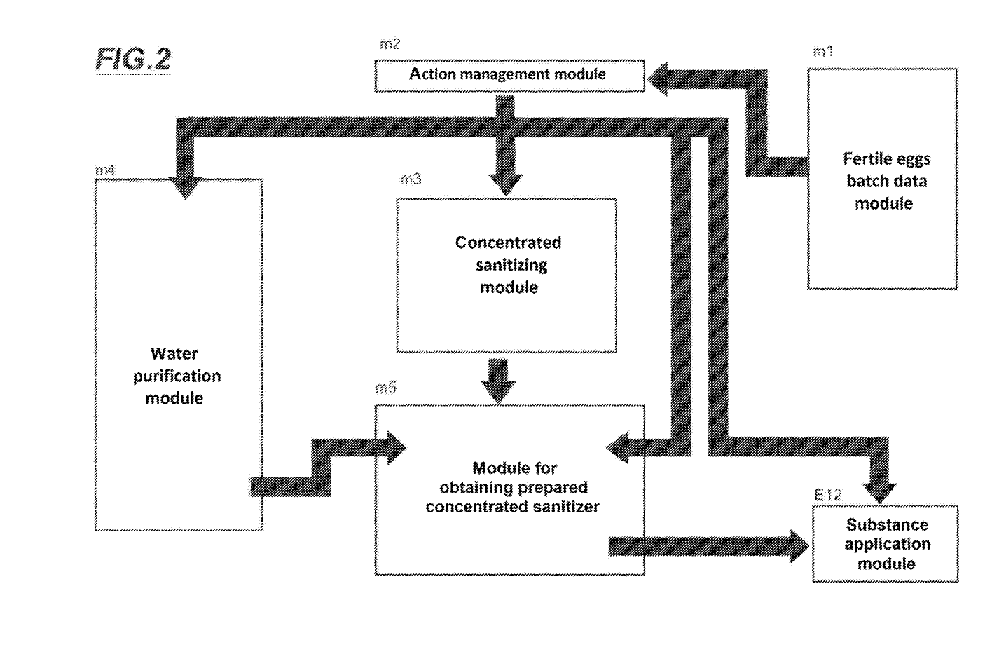

As shown in FIG. 2 it is composed of the following operational modules:

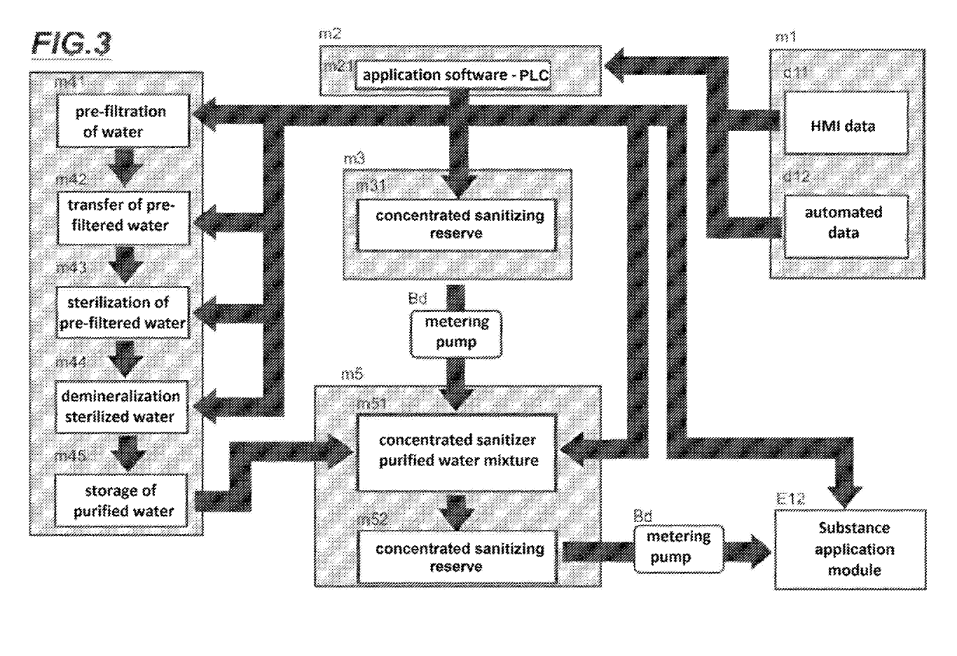

b.1 Fertile egg batch data module (M1), as shown in FIG. 3, is digitally loaded into an operational management system, and such data have two possible sources:
Human machine interface data (D11), in which the system operator receives information on the average size of the eggs (Tm1), carried out by means of human observation, through a printed or digital data sheet with information of the incubated egg stock that defines the most likely average classification of eggs as average size of large eggs, average size of medium eggs, and average size of small eggs.
Automated fertile egg mean data (D12), where the system operator receives information on the average size of the eggs (Tm2), performed by means of an automated system for calculating the average size of a batch of fertile eggs, through innumerable known technologies, among which the technique disclosed in the Brazilian patent application PI BR No. 10 2015 020511-2 entitled “SYSTEM OF RECOGNITION AND CLASSIFICATION OF THE HEIGHT OF FERTILE EGGS DERIVING FROM THE CANDLING STAGE AND OPERATIONAL PROCEDURE OF ITS SUBMODULES AND OF APPLICATION MODULES AND BREEDING”, which more accurately defines the actual classification of eggs as average size of large eggs, average size of medium eggs, and average size of small eggs.

b.2 Action management module (M2), as shown in FIGS. 2 and 3, is formed by an application software (d21), which uses a logic programmer (PLC), where it performs calculations for the variables of the water purification module (M4), the concentrated sanitizer preparation module (M3) and module of purified water mixture+concentrated sanitizer (M5).

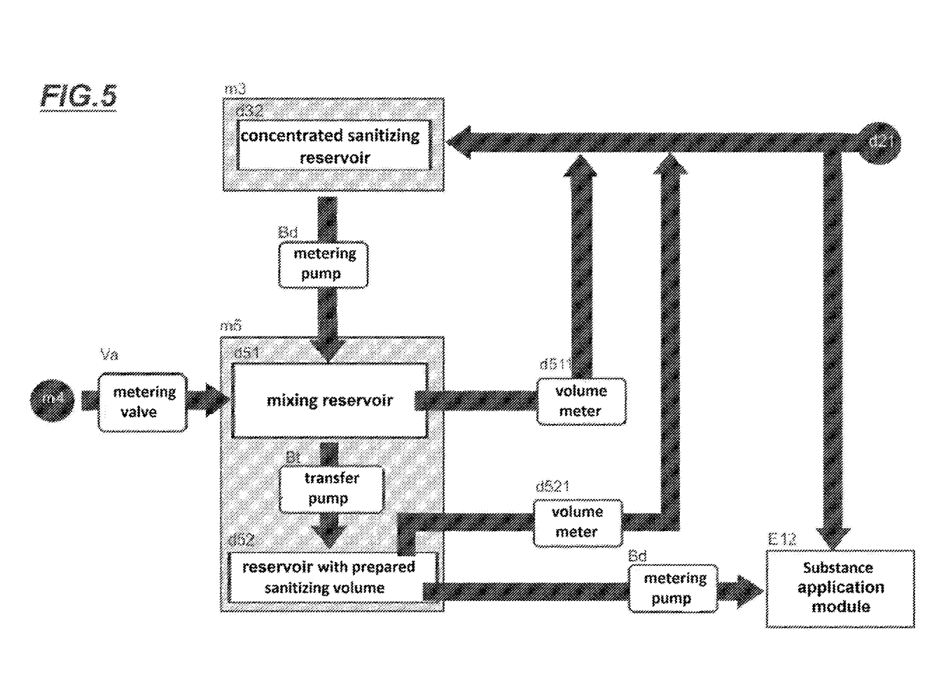

b.3 Concentrated sanitizing module (M3), as evidenced in FIGS. 3 and 5, it has the function to ensure that a volume of concentrated sanitizer with adequate titration for the age characteristic of the fertile egg batch is obtained and that such information derives from the batch data of fertile eggs (M1) and sent through by the activity management module (M2). For this purpose, the concentrated sanitizing reserve submodule (m31) is formed, where the volume of concentrated sanitizer (Sa31) is stored in a concentrated sanitizing reservoir (d31);

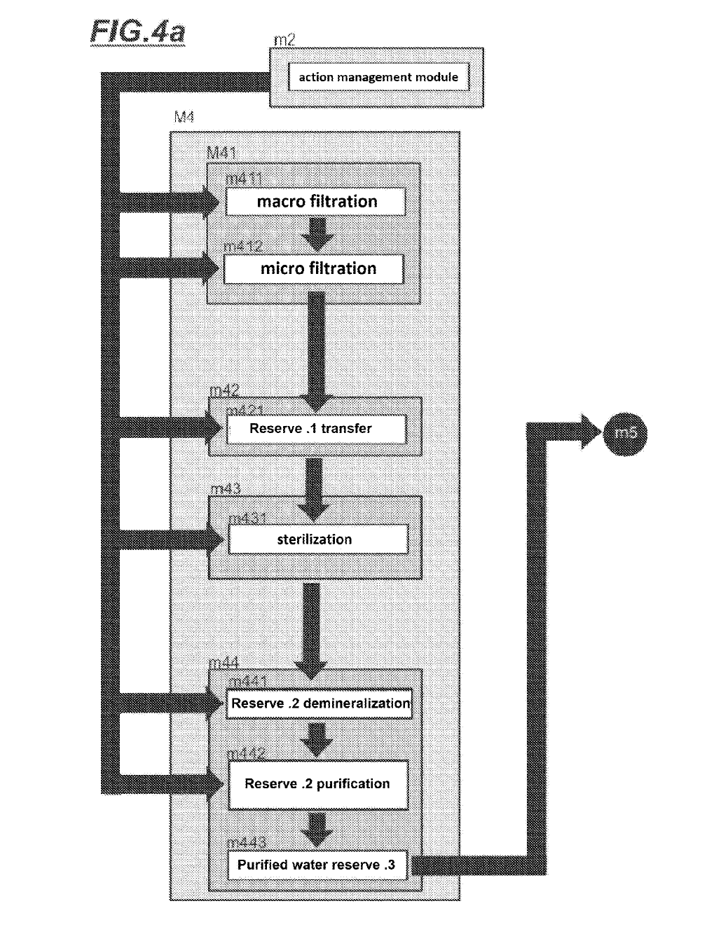

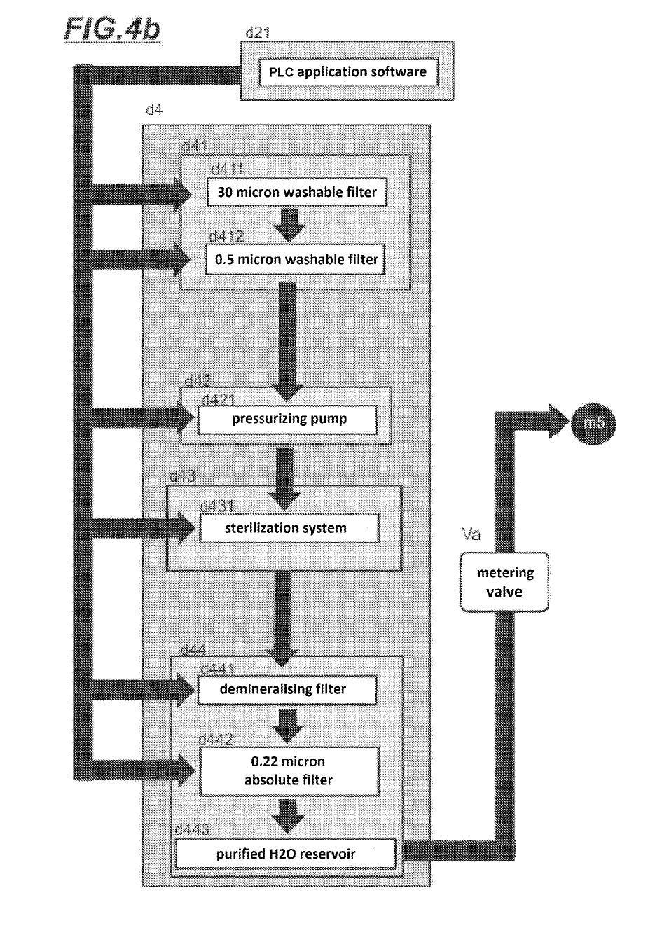

b.4 Water purification module (M4) has the function to ensure that the water to be used to obtain the batch of the prepared concentrated sanitizer (m52) is devoid of contamination, and for this purpose, it is formed by the following operational sub modules, see FIG. 3, wherein:
Water prefiltration submodule (m41): as shown in FIGS. 3, 4a and 4b is formed by the submodules:
Macro filtration submodule (m411), where it receives from the application software device (d21) the macro variable time control variable information (V411), and initiates the procedure whereby the volume of untreated water passes a first filtration, called macro filtration, performed by a 30 micron washable filter (d411), thus obtaining the volume of macro filtered water (Ag411);
Micro filtration submodule (m412): it receives from the application software device (d21) the micro filtration variable time control information (V412) and initiates the procedure wherein the volume of macro filtered water (Ag411) passes a second filter, called micro filtration, performed by a 05 micron washable filter (d412), thus obtaining the volume of micro filtered water (Ag412);
Prefiltered water transfer submodule (m42): as shown in FIGS. 3, 4a and 4b is formed by the submodule:
Reserve .1 transfer submodule (m412): wherein it receives from the application software device (d21) information regarding the transfer time variable (V421), wherein by means of a pressurizing pump (d421) the volume of micro filtered water (Ag412) is transferred to the reservoir of the prefiltered water sterilization submodule (m43);
Prefiltered water sterilization submodule (m43): as shown in FIGS. 3, 4a and 4b is formed by the submodules:
Sterilization submodule (m431): wherein it receives from the software application device (d21) the information of the sterilization control variable (V432) that varies in accordance with the adopted sterilization technology (ozonation and/or reverse osmosis and/or ultraviolet radiation where the latter is chosen as a preferred embodiment because it involves lower energy consumption and has no residue.

Immediately the procedure is initiated where the volume of micro filtered water (Ag412) is exposed to a sterilization process, generating a resulting volume of sterilized water (Ag431);
Sterilized water demineralization submodule (m44): as shown in the FIGS. 3, 4a and 4b is formed by the submodule:
Reserve .2 demineralization submodule (m441): where it receives from the application software device (d21) the information of the filtering time variable (V441), and initiates the procedure wherein the volume of sterilized water (Ag431) passes through a demineralization filter (d441), thus obtaining the volume of micro sterilized demineralized water (Ag441);
Reserve .2 purification submodule (m442): where it receives from the application software device (d21) the information of the filtering time control variable (V442), and initiates the procedure whereby the volume of sterilized demineralized water (Ag441) passes through a purification filter, performed by a 0.22 micron absolute filter (d442), thus obtaining the volume of purified water (Ag442);
Purified water reserve .3 submodule (m443): wherein the volume of purified water (Ag442) is stored in a purified water reservoir (d443), notably an airtight reservoir.

b.5 Module for obtaining prepared concentrated sanitizer (M5): has the function of guaranteeing the quality reliability in concentration of the volume of treated concentrated sanitizer, so that it can effectively supply the disinfection procedure of the substance application module (E13), for this purpose is formed by the following operating submodules see FIGS. 3 and 5, where:
Concentrated sanitizer purified water mixture submodule (m51): wherein it first receives from the application software device (d21) the information of the following mixing variables (V51):
Mixing variable (V511), amount of volume of purified water (Ag442) to be mixed;
Mixing variable (V512), amount of volume of concentrated sanitizer (Sa31) to be mixed;

These values are calculated based on values of the desired concentration and initial concentration of the concentrated sanitizing solution.
Mixing Variable (V513): mixing time of volume of concentrated sanitizer (Sa31) with volume of purified water (Ag442);

The mixing procedure is then initiated wherein the desired volume of purified water (Ag442) is transported from the purified water reservoir (d443) to the mixing reservoir (d51), the control of this alimentation is carried out by means of a metering valve (Va) installed in the communicating connection of the purified water reservoir (d443) with the mixing reservoir (d51), wherein the opening control of this metering valve (Va) is performed by the volume metering device (d511), which effectively sends the volume data to the application software (d2), which sends a supply interruption command, see FIGS. 4b and 5;

In the same way, desired volume of concentrated sanitizer (Sa31) is transported from the concentrated sanitizing reservoir (d32) to the mixing recipient (d51), wherein the operational control of the metering pump (Va) is performed by the volume metering device (d511), which effectively sends the volume data to the application software (d2), which sends a supply interruption command, see FIG. 5;

Finally, the volume of concentrated sanitizer (Sa31) with volume of purified water (Ag442) is obtained, and also the final volume of prepared concentrated sanitizer (Sa51);
Prepared concentrated sanitizing reserve submodule (m52): where the volume of prepared concentrated sanitizer (Sa51) is stored by means of a transfer pump (Bt) in the sanitizing reservoir (d52);

c. Sanitization substance application module (Ell): as shown in FIGS. 2, 3 and 5, the module receives from the application software device (d21) the volume information of volume of concentrated sanitizer (Sa31), where it then triggers supply from the sanitizing reservoir (d52), the supply control being carried out by the metering pump (Bd) present in the connection between that reservoir and the flow circuit of the substance application module.

The prepared concentrated sanitizing reservoir (d52) has a volume meter (d521), which is useful in determining the prepared volume of concentrated sanitizer (Sa31) inside.

Such volume meter (d521) works with maximum and minimum values, and when the minimum value is reached, the limiting volume data is sent to the application software (d2), which initializes a new operational process for the production of a new prepared volume of concentrated sanitizer (Sa31).

The choice of the preferred embodiment of the invention object of claim in this cartouche and described in this detailing section is provided by way of example only. Changes, modifications, and variations may be made to any other embodiments of the system for managing optimized volume and concentration of sanitizer where changes may be devised by those skilled in the art without, however, diverging from the goal disclosed in patent application, which is exclusively defined by the appended claims.

It is verified by what has been described and illustrated that the “SYSTEM AND PROCESS OF OBTAINING VOLUME AND CONCENTRATION OF SANITIZER OPTIMIZED FOR THE APPLICATION IN THE DISINFECTION PROCEDURE OF AN IN OVO SUBSTANCE APPLICATOR MODULE HAVING AS A PARADIGM THE INFORMATION ON THE AVERAGE SIZE OF THE VACCINATED AND/OR FED FERTILE EGGS” herein claimed conforms to the rules governing the invention patent in the light of the Industrial Property Law, deserving from what has been stated and as a consequence, the respective privilege.

1. System and process of obtaining and managing the volume and concentration of sanitizer optimized for the application in the disinfection procedure of an in ovo substance applicator module having as a paradigm the information on the average size of the vaccinated and/or fed fertile eggs whose macro architecture is characterized in that it is composed of a fertile egg batch data module (M1), which provides humanmachine interface data (D11), wherein the system operator receives information on the average egg size (Tm1), performed by means of the observation of a printed or digital record with information on the batch of incubated eggs, which in turn is communicated as a data transmitter with the action management module (M2), formed by an application software (d21), which uses a logic programmer (PLC), wherein this software application (d21) sends operational data of the concentrated sanitizing module (M3) formed by the concentrated sanitizing reserve submodule (m31), this application software (d21) sends data to the water purification module (M4) formed by the sequential submodules of the prewater filtration module (m41), pre filtered water transfer submodule (m42), prefiltered water sterilization submodule (m43) and of sterilized water demineralization submodule (m44), wherein this water purification module (M4) feeds the module for obtaining prepared concentrated sanitizer (M5) also with application software command control (sw2), wherein this module for obtaining prepared concentrated sanitizer (M5) is formed by sequential sub modules, namely concentrated sanitizer purified water mixture submodule (m51), prepared concentrated sanitizing reserve submodule (m52), also controlled by receiving and sending commands from the application software (sw2), where the supply of prepared concentrated sanitizer (Sa51) to the application module is also controlled by application software commands (sw2).

2. System and process of obtaining and managing the volume and concentration of sanitizer optimized for the application in the disinfection procedure of an in ovo substance applicator module having as a paradigm the information on the average size of the vaccinated and/or fed fertile eggs according to claim 1, wherein the fertile egg batch data module (M1) in an alternative embodiment is characterized in that it provides automated fertile egg average size data (D12), wherein the system operator receives information on the average egg size (Tm2) by means of an automated system of calculation of the average size of a batch of fertile eggs.

3. System and process of obtaining and managing the volume and concentration of sanitizer optimized for the application in the disinfection procedure of an in ovo substance applicator module having as a paradigm the information on the average size of the vaccinated and/or fed fertile eggs according to claim 1, wherein for the water purification module (M4) the water prefiltration submodule (m41) is characterized in that it is formed by the sequential submodules and macro filtration submodule (m411), micro filtration submodule (m412).

4. System and process of obtaining and managing the volume and concentration of sanitizer optimized for the application in the disinfection procedure of an in ovo substance applicator module having as a paradigm the information on the average size of the vaccinated and/or fed fertile eggs according to claim 3, wherein the macro filtration submodule (m411) is characterized in that it receives the information of the macro filtration time control variable (V411) from the application software device (d21), and initiates the procedure in which the volume of untreated water passes a first filtration, called macro filtration, performed by a 30 micron washable filter (d411), for obtaining the volume of macro filtered water (Ag411).

5. System and process of obtaining and managing the volume and concentration of sanitizer optimized for the application in the disinfection procedure of an in ovo substance applicator module having as a paradigm the information on the average size of the vaccinated and/or fed fertile eggs according to claim 3, wherein the micro filtration submodule (m412) is characterized in that it receives the information of the micro filtration time control variable (V412) from the application software device (d21), and initiates the procedure in which the volume of macro filtered water (Ag411) passes a second filtration, called micro filtration, performed by a 05 micron washable filter (d412), for obtaining the volume of micro filtered water (Ag412).

6. System and process of obtaining and managing the volume and concentration of sanitizer optimized for the application in the disinfection procedure of an in ovo substance applicator module having as a paradigm the information on the average size of the vaccinated and/or fed fertile eggs according to claim 1, wherein for the water purification module (M4), the prefiltered water transfer submodule (m42) is characterized in that it is formed by the reserve .1 transfer submodule (m421) where it receives the information of the transfer time variable (V421) from the application software device (d21), and by means of a pressurizing pump (d421) the volume of micro filtered water (Ag412) is transferred to the sterilization submodule (m431).

7. System and process of obtaining and managing the volume and concentration of sanitizer optimized for the application in the disinfection procedure of an in ovo substance applicator module having as a paradigm the information on the average size of the vaccinated and/or fed fertile eggs according to claim 1, wherein for the water purification module (M4) the prefiltered water sterilization submodule (m43) is characterized in that it is formed by the sterilization submodule (m431) receiving from the application software device (d21) the information about the sterilization control variables (V432) to subsequently initiate the procedure in which the volume of micro filtered water (Ag412) is exposed to a sterilization process, generating a resulting volume of sterilized water (Ag431).

8. System and process of obtaining and managing the volume and concentration of sanitizer optimized for the application in the disinfection procedure of an in ovo substance applicator module having as a paradigm the information on the average size of the vaccinated and/or fed fertile eggs according to claim 7, wherein the sterilization technology is characterized in that it is an ozonation technology.

9. System and process of obtaining and managing the volume and concentration of sanitizer optimized for the application in the disinfection procedure of an in ovo substance applicator module having as a paradigm the information on the average size of the vaccinated and/or fed fertile eggs according to claim 7, wherein the sterilization technology is characterized in that it is a reverse osmosis technology.

10. System and process of obtaining and managing the volume and concentration of sanitizer optimized for the application in the disinfection procedure of an in ovo substance applicator module having as a paradigm the information on the average size of the vaccinated and/or fed fertile eggs according to claim 7, wherein the sterilization technology is characterized in that it is an ultraviolet radiation technology.

11. System and process of obtaining and managing the volume and concentration of sanitizer optimized for the application in the disinfection procedure of an in ovo substance applicator module having as a paradigm the information on the average size of the vaccinated and/or fed fertile eggs according to claim 1, wherein for the water purification module (M4), the sterilized water demineralization submodule (m44) is characterized in that it is formed by the sequential submodules, reserve .2 demineralization submodule (m441), reserve .2 purification submodule (m442) and purified water reserve .3 submodule (m443).

12. System and process of obtaining and managing the volume and concentration of sanitizer optimized for the application in the disinfection procedure of an in ovo substance applicator module having as a paradigm the information on the average size of the vaccinated and/or fed fertile eggs according to claim 11, wherein the reserve .2 demineralization submodule (m441) is characterized in that it receives the information of the filtering time variable (V441) from the application software device (d21), and then initiates the procedure whereby the volume of sterilized water (Ag431) undergoes a demineralization filtration carried out by a demineralized filter (d441), thus obtaining the volume of micro sterilized demineralized water (Ag441).

13. System and process of obtaining and managing the volume and concentration of sanitizer optimized for the application in the disinfection procedure of an in ovo substance applicator module having as a paradigm the information on the average size of the vaccinated and/or fed fertile eggs according to claim 11, wherein the reserve .2 purification submodule (m442) is characterized in that it receives from the application software device (d21) the information of the filtering time control variable (V442) and initiates the procedure whereby the volume of sterilized demineralized water (Ag441) passes through a purification filter, performed by a 0.22 micron absolute filter (d442), obtaining the volume of purified water (Ag442).

14. System and process of obtaining and managing the volume and concentration of sanitizer optimized for the application in the disinfection procedure of an in ovo substance applicator module having as a paradigm the information on the average size of the vaccinated and/or fed fertile eggs according to claim 11, wherein the purified water reserve .3 submodule (m443) is characterized in that it receives a volume of purified water (Ag442) which is stored in a purified water reservoir (d443).

15. System and process of obtaining and managing the volume and concentration of sanitizer optimized for the application in the disinfection procedure of an in ovo substance applicator module having as a paradigm the information on the average size of the vaccinated and/or fed fertile eggs according to claim 14, wherein the purified water reservoir (d443) is characterized in that it is an airtight reservoir.

16. System and process of obtaining and managing the volume and concentration of sanitizer optimized for the application in the disinfection procedure of an in ovo substance applicator module having as a paradigm the information on the average size of the vaccinated and/or fed fertile eggs according to claim 1, wherein for the module for obtaining prepared concentrated sanitizer (M5), the concentrated sanitizer purified water mixture submodule (m51) is characterized in that it receives from the application software device (d21) the information of the mixing variables (V51), mixing variable (V511), amount of volume of purified water (Ag442) to be mixed; mixing variable (V512), amount of volume of concentrated sanitizer (Sa31) to be mixed and mixing variable (V513), as the mixing time of volume of concentrated sanitizer (Sa31) with volume of purified water (Ag442), initiating the mixing procedure, wherein the desired volume of purified water (Ag442) is transported from the purified water reservoir (d443) to the mixture reservoir (d51), wherein the control of this alimentation is carried out by means of a metering valve (Va) installed in the communicating connection of the purified water reservoir (d443) with the mixing reservoir (d51), wherein the opening control of this metering valve (Va) is performed by the volume metering device (d511), which effectively sends the volume data to the application software (d2), which sends a supply interruption command; simultaneously the desired volume of concentrated sanitizer (Sa31) is transported from the concentrated sanitizing reservoir (d31) to the mixing recipient (d51), wherein the operational control of the metering pump (Va) is performed by the volume metering device (d511), which sends the volume data to the application software (d2), which sends a supply interruption command, wherein the volume of concentrated sanitizer (Sa31) with volume of purified water (Ag442) is obtained, and also the final volume of prepared concentrated sanitizer (Sa51).

17. System and process of obtaining and managing the volume and concentration of sanitizer optimized for the application in the disinfection procedure of an in ovo substance applicator module having as a paradigm the information on the average size of the vaccinated and/or fed fertile eggs according to claim 1, wherein for the module for obtaining prepared concentrated sanitizer (M5), the prepared concentrated sanitizing reserve submodule (m52) is characterized in that the volume of prepared concentrated sanitizer (Sa51) is stored by means of a transfer pump (Bt) in the sanitizing reservoir (d52) with a volume meter (d521).

18. Disinfection procedure of an in ovo substance applicator module having as a paradigm the information on the average size of the vaccinated/fed fertile eggs characterized in that the substance application module (E12) receives from the application software device (d21) the information of the prepared volume of concentrated sanitizer (Sa31), where it then activates its delivery from the prepared concentrated sanitizer reservoir (d51), wherein the supply control is performed by the metering pump (Bd) present in the connection between this reservoir and the substance flow circuit of the substance application module (E12), where the prepared concentrated sanitizer reservoir (d52) has a volume meter (d521), which determines the prepared volume of concentrated sanitizer (Sa31) inside.

19. Disinfection procedure of an in ovo substance applicator module having as a paradigm the information on the average size of the vaccinated/fed fertile eggs according to claim 18, wherein the volume meter (d521) is characterized in that it has maximum and minimum values, wherein when the minimum value is reached, the limiting volume data is sent to the application software (d21), which initializes a new operational process for the production of a new prepared volume of concentrated sanitizer (Sa31).
